(19) United States
(12) Patent Application Publication
(10) Pub. No.: US 2020/0047320 A1
(43) Pub. Date: Feb. 13, 2020

(54) Spring Removal Tool for Air Brake Shoes

(71) Applicant: Ole Luangphon, Goodyear, AZ (US)

(72) Inventor: Ole Luangphon, Goodyear, AZ (US)

(21) Appl. No.: 16/056,552

(22) Filed: Aug. 7, 2018

(51) Int. Cl. B25B 27/30

(52) U.S. Cl. CPC B25B 27/306

(57) ABSTRACT

A tool for attaching and disengaging a retainer spring in a truck brake assembly comprises a handle, a supporting curved member, a stabilizing tab and a fulcrum rod that enables a mechanic to engage and move into place the retainer spring using a long bar. An optional lever bar with a partially closed hook may be used to more effectively control the retainer spring during the operation.

### BACKGROUND OF THE INVENTION

The present invention relates to servicing of the brakes on large trucks, primarily tractor-trailer configurations. It provides a convenient tool for the disassembly and reassembly of the wheel-mounted portion of the brake mechanism when the unit must be serviced

A typical configuration for truck/trailer air brakes is a pair of approximately semi-circular components called “shoes,” each contacting half of a circular brake drum surrounding the axle of the vehicle. Brake linings, which may be metal or ceramic composites designed to withstand the heat and pressure of substantial friction, are attached to the outer surface of the shoes. When a brake pedal is depressed, a compressed air delivery network causes a cam to turn, which pushes the brake shoes outward, causing the lining to frictionally engage the surrounding drum as it rotates, slowing its motion to a stop.

The brake shoes are attached to a spider, a round plate on the end of the axle, by anchor pins or other components. The brake shoes are movably secured to each other by springs, so that after the brake pedal is released, the shoes and linings withdraw from contact with the drums. Most brake assemblies have one or two retainer springs on one side of the axle and a return spring on the side of the axle adjacent the cam. The return spring must quickly pull the shoe away from the drum when the brake is released, and such springs are very strong, often 100 lb tension or more. When truck brakes are serviced, the shoes must be removed to replace the linings, and this entails stretching the retainer and return springs to remove them from their anchor positions. These springs are usually replaced as part of the service. The return spring, in particular, is difficult to stretch. Service personnel must find a way to carefully apply leverage to disengage either the return spring or the retainer springs, permitting them to remove the remaining spring more easily, as described in U.S. Pat. No. 8,931,150 (Luangphon). When standard tools, such as screwdrivers, pry bars or pliers are used, frustration and injuries can result as the spring slips from the tool.

### SUMMARY OF THE INVENTION

The present invention provides a tool for removing and for reattaching the retaining spring on a common air brake configuration in the industry, the Eaton ES2 brake systems made by the Eaton Corporation. ES2 brake shoe replacement kits are made by a number of major manufacturers. The invention takes advantage of the shape of the retaining springs and the configuration of the shoe and lining, and may also be useful in handling the retaining spring in other systems. The tool incorporates a handle, a supporting curved member, a stabilizing tab and a fulcrum rod that enables a mechanic to engage and release the retainer spring using a long bar.

### BRIEF DESCRIPTION OF THE DRAWINGS

FIG. 1 is a depiction of a truck air brake assembly.

FIG. 2 is a diagram showing the spring set for an ES2 style brake.

FIG. 3 is a depiction of an embodiment of a spring attachment tool with a companion lever bar.

FIG. 4 is a drawing of the embodiment of FIG. 3 in place on a brake assembly.

FIG. 5 is a drawing showing the first step of positioning the spring attachment tool on the brake assembly.

FIG. 6 is a drawing showing the second step of positioning the spring attachment tool on the brake assembly.

FIG. 7 is a drawing showing an embodiment of the spring attachment tool in place on the brake assembly, with a lever bar positioned to engage the retaining spring.

FIG. 8 shows the embodiment of FIG. 8 with the retaining spring engaged by the lever bar.

FIG. 9 shows an embodiment of the spring attachment tool used with a long screwdriver.

### DETAILED DESCRIPTION

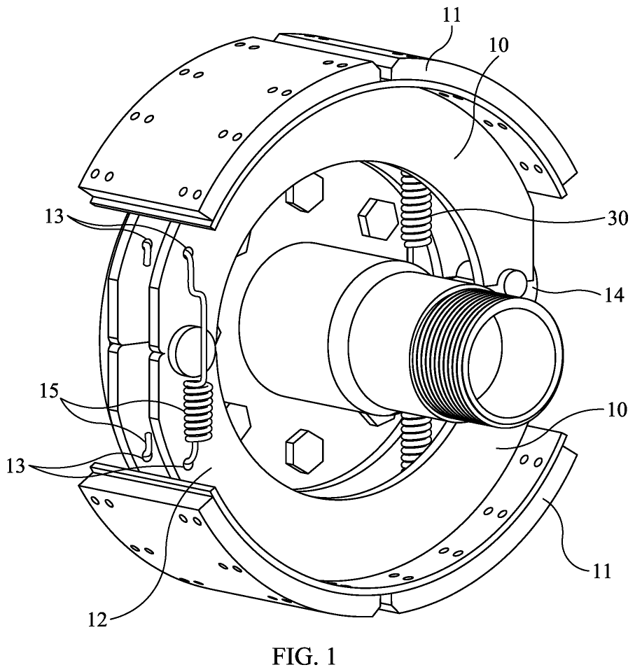

The configuration of the ES2 brake assemblies is shown in FIG. 1. Brake shoes 10 with attached linings 11 are on top and bottom halves of a circular configuration. Cam 14, when rotated by the air pressure system activated by the driver's brake pedal, forces the shoes outward so the linings contact the surrounding drum (not shown) and slow the rotation of the wheel. A pair of retaining springs 15 (only one shown), hooked through apertures 13 in the web 12 of the shoe 10 on the opposite side from the cam 14, and a return spring 30 hooked over upper and lower return spring retainers (not shown) hold the shoes together.

The recommended method for disassembly of the brake involves releasing the retaining springs 15 first, then the return spring 30. With the retaining springs unhooked, the upper and lower shoes may be rotated to release the tension on the return spring, allowing it to be disengaged. (This is similar to the method of disassembling the brake shown in U.S. Pat. No. 8,931,150, except that in that patent the return spring is disengaged before the retaining springs.) Similarly, on assembly the return spring 30 is set and then the springs 15 are attached. Because of the strength of the retaining springs, a tool is needed to stretch the springs 15 out of their respective apertures 13. Mechanics may use a long screwdriver, a pry bar or long-handled pliers to pull the spring end over the retainer. These tools sometimes slip, resulting in frustration and occasional hand injuries.

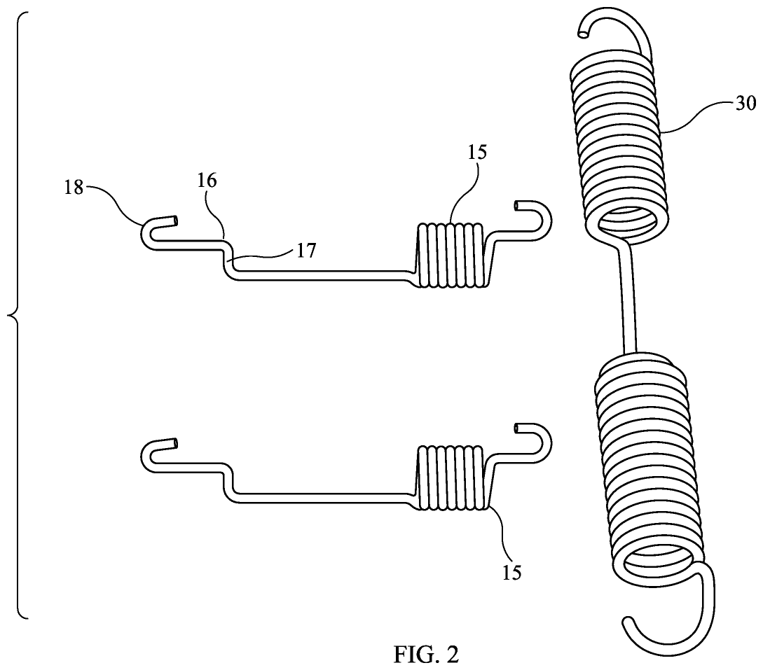

The present invention is a tool configured to stretch a retainer spring onto or off the retaining spring apertures 13. The replacement kit for the ES2 brake includes a return spring 30 and two retaining springs 15 as seen in FIG. 2. Other components (such as brake shoes) are also included in the kit but not shown here. The present invention takes advantage of the fact that the retaining springs 15 for this brake incorporate a double 90 degree turn 16 near the hook 18, leaving a horizontal leg 17 in the spring.

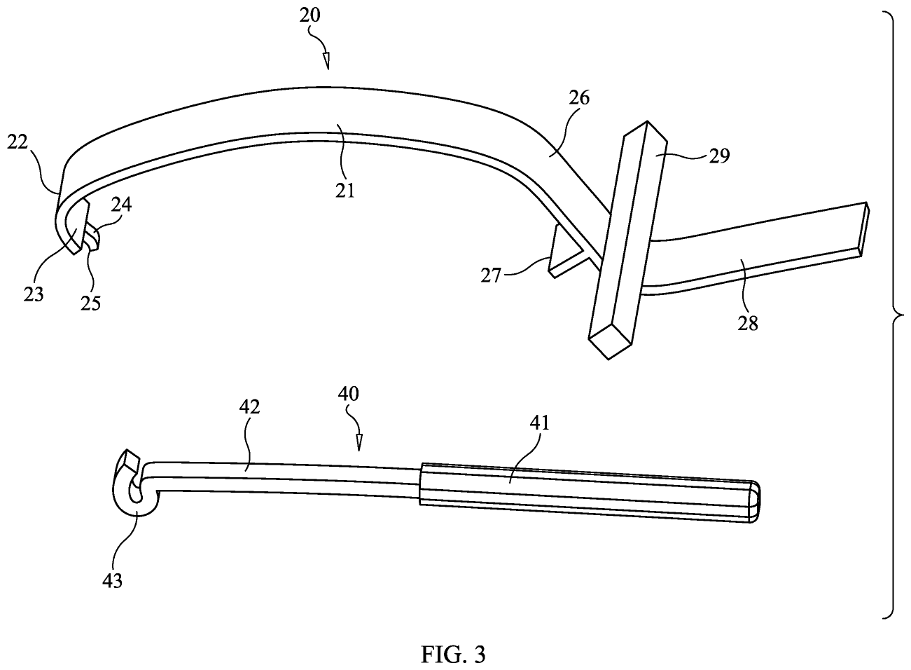

One embodiment of the tool 20 is shown in FIG. 3. It comprises a curved main body 21 with an approximately 90 degree curved bend 22 at its distal end and a supporting extension 26 and handle portion 28 at the other end. The curvature of the main body corresponds to the external curvature of the brake lining upon which it is operating. The bend at the distal end forms a stabilizing arm 23 that fits in a slot in the ES2 brake lining, as described below, and includes a securing tab 24 that inserts into an aperture in the brake pad slot. The securing tab may include a slight outward curvature 25 to help keep the device from slipping. Toward the proximal end, a support leg 27 extends under the curved body 21 and a fulcrum crossbar 29 is attached to a handle portion 28.

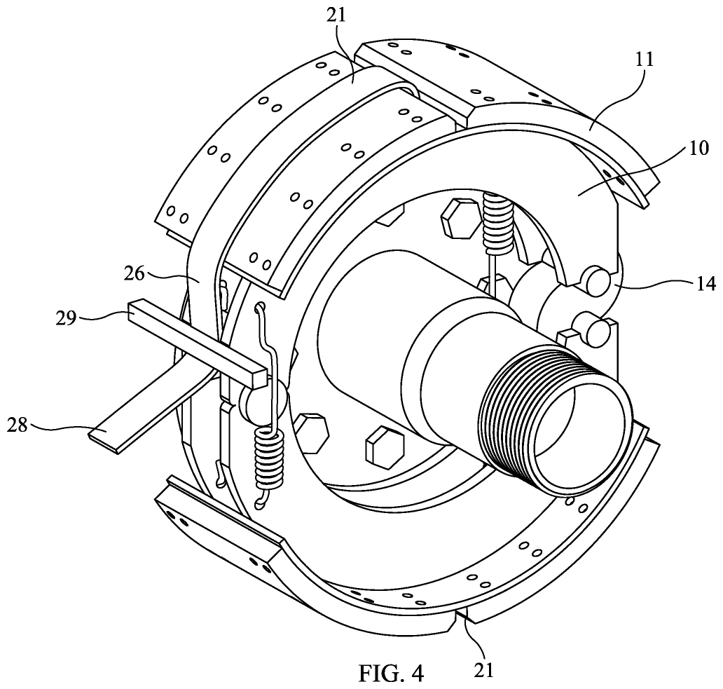

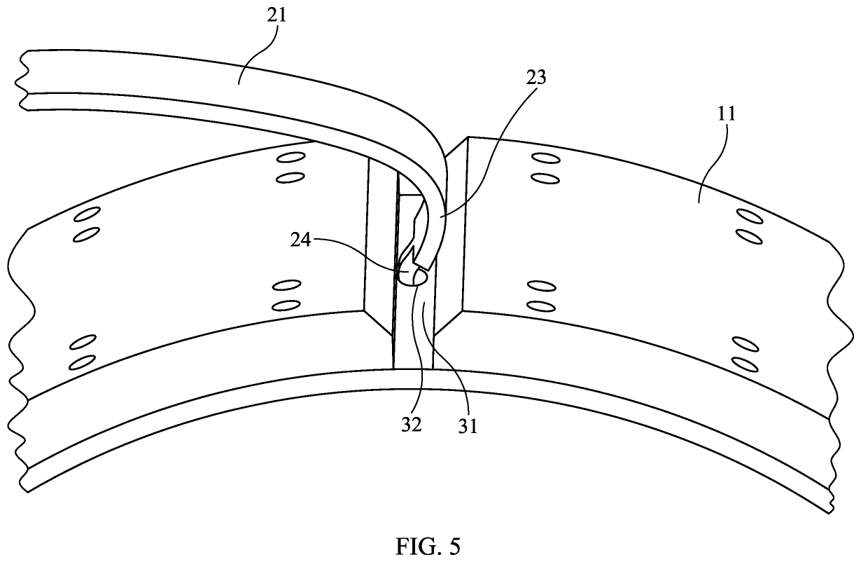

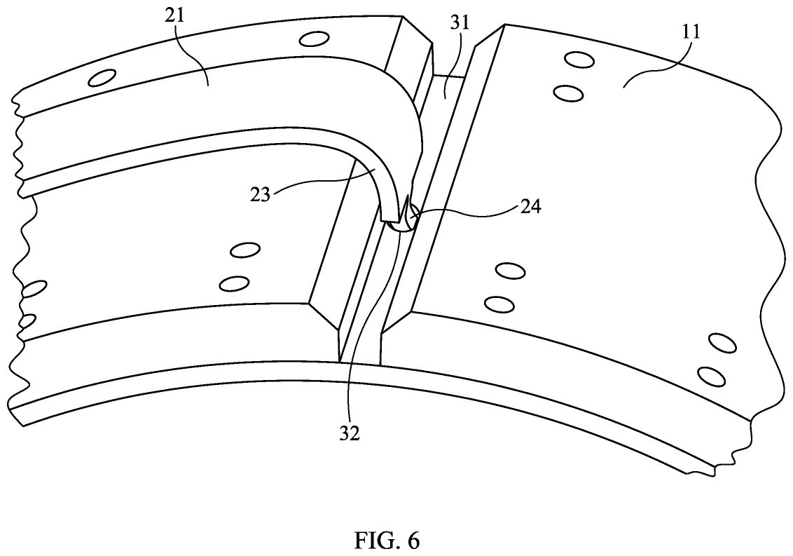

Use of the tool can be understood with reference to FIGS. 4-8. The upper and lower brake linings 11 and shoes 10, which are interchangeable, are curved to fit the generally circular shape of the brake. In the ES2 configuration, the lining includes a slot 31 across the width of the lining and an aperture 32 in the center of the slot. The tool 20 is laid on top of the lining 11, its curvature matching that of the shoe. The stabilizing arm 23 fits over the edge of and down into the slot 21, and the securing tab 24 is inserted into aperture 32. In operation, the user holds the tool by the handle 28, inserts the securing tab into the aperture (FIG. 5), and then brings the tool body down to rest on the brake lining (FIG. 6).

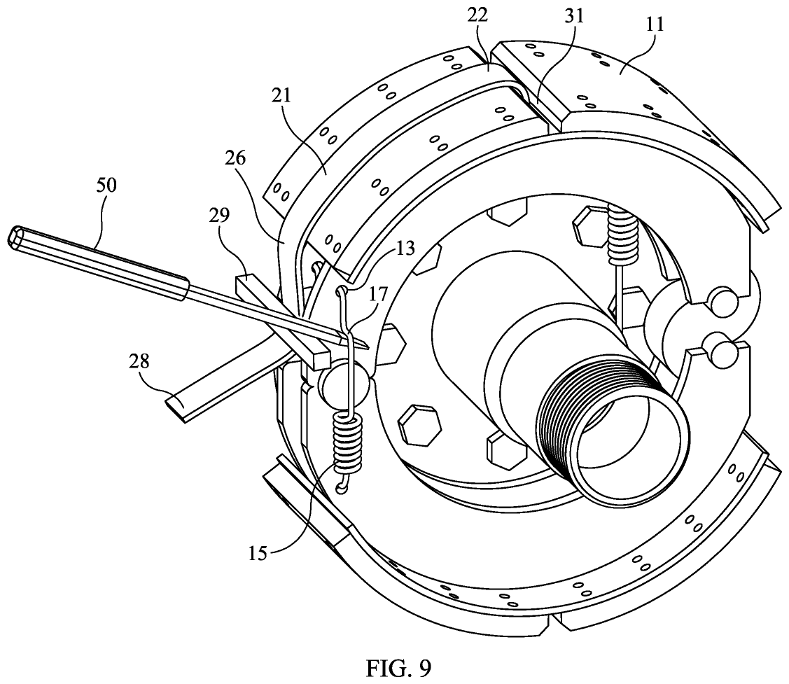

With the tool resting along the brake lining, the support leg 27 is brought into contact with the body of the brake, and the fulcrum crossbar 29 is positioned approximately parallel to the horizontal leg 17 of the retaining spring 15. An elongated strong bar, such as a long-handled screwdriver or a pry bar, may be placed on top of the fulcrum crossbar 29 and below the horizontal leg 17 of the retaining spring 15, and used as a lever to stretch the spring and move its hook out of the retaining spring aperture 13. See FIG. 9. Because of the high tension in spring 15, the bar must be long enough to provide sufficient leverage to stretch the spring. Also, controlled lateral movement of the hook 18 may be difficult, but a mechanic of reasonable dexterity may be able to grasp and move the hook with pliers with one hand while maintaining pressure on the lever bar with the other.

The two retaining springs must both be removed before the shoes can be rotated into a separated position allowing the return spring to be disengaged.

Reassembly of the shoes (usually with new linings) is accomplished in the same manner. The return spring is engaged in the upper and lower shoes and the apparatus is set in place around the brake hub. The tool is placed on the brake lining as previously described, the bottom hook of the retaining spring is inserted in its aperture in the shoe, and the lever arm is placed over the fulcrum crossbar and under the horizontal leg of the spring. The spring is stretched and maneuvered so that the upper hook engages the retaining spring aperture. This must be done for both retaining springs.

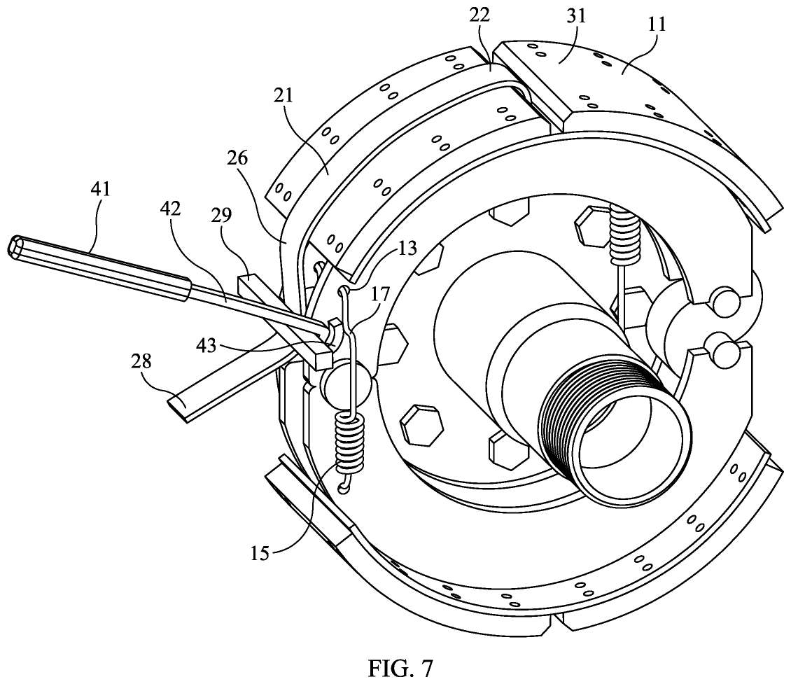

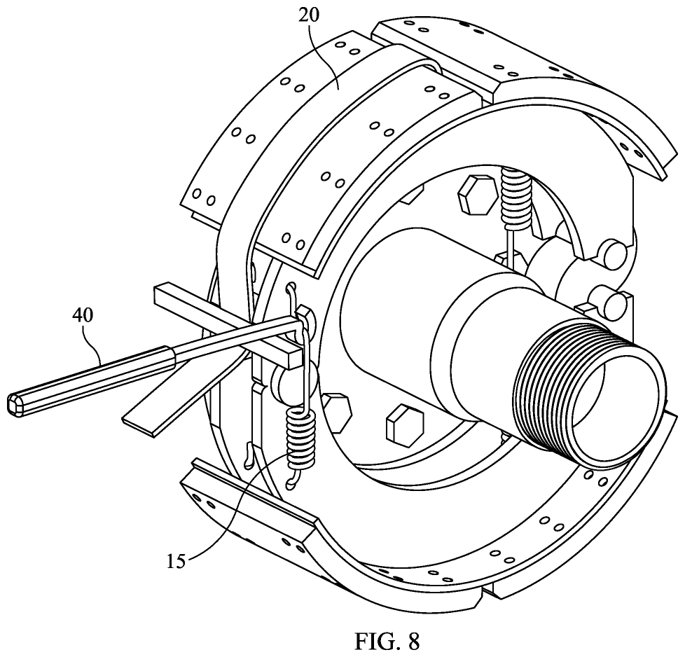

Because of the aforementioned difficulty in controlling the upper hook of retaining spring 15 while stretching the spring, an additional component is a part of a preferred embodiment. As seen in FIG. 3, a spring lever arm 40 comprises a handle portion 41, a force bar portion 42, and a partially closed hook 43 on the end opposite the handle. As seen in FIGS. 7 and 8, the spring lever arm 40 is rested on the fulcrum crossbar and the hook engages the horizontal leg 17 of the retaining spring 15. Pushing down on the handle causes the hook to move upward with a force multiplied by the lever action based on the relative lengths of the shorter and longer arms from the fulcrum. The partially closed hook secures the upper part of the retaining spring from getting away during the operation.

Because of the force needed to extend the springs, the tool must be made from a strong material. For example, the main tool may be made from one-quarter inch steel plate 1¼ inches wide or the equivalent. In an embodiment a 17 inch such plate may be bent into the appropriate shape and a tab added on the distal end and a ½ inch×⅜ inch crossbar about 5½ inches long. The steel lever arm may be about 12 inches long.

The foregoing description has been presented and is intended for the purposes of illustration and description. It is not intended to be exhaustive nor limit the invention to the above teachings. The embodiments were chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

I claim:

1. A tool for attaching a retaining spring to a brake assembly, comprising a handle portion, a curved main body with a curvature matching an external radius of the brake assembly, a supporting extension connecting the handle to the curved body, a fulcrum crossbar attached to the handle such that in operation it will be positioned near the retaining spring, a curved bend at the distal end of the main body forming a stabilizing arm, and a securing tab extending from the stabilizing arm dimensioned to fit into an aperture in a groove on the brake assembly.

2. The tool of claim 1 further comprising a support leg extending under the main body near the fulcrum crossbar.

3. The tool of claim 1 wherein the securing tab has a small outward curvature.

4. The tool of claim 2 wherein the securing tab has a small outward curvature.

5. The tool of claim 4 further including a lever arm in removable contact with the fulcrum crossbar, comprising a handle portion, a force bar portion, and a partially closed hook on a distal end opposite the handle.

6. A tool for attaching a retaining spring to a brake assembly, comprising a handle portion, a curved main body with a curvature matching an external radius of the brake assembly, a supporting extension connecting the handle to the curved body, a fulcrum crossbar attached to the handle such that in operation it will be positioned near the retaining spring, and a means for removably securing the distal end of the tool to the brake assembly.

7. The tool of claim 6, further including a means for releasably engaging and stretching the spring using the fulcrum crossbar as a lever fulcrum.

8. A method for stretching a brake assembly retaining spring to release or attach the spring, comprising the steps of
providing a tool comprising a handle portion, a curved main body with a curvature matching an external radius of the brake assembly, a supporting extension connecting the handle to the curved body, a fulcrum crossbar attached to the handle such that in operation it will be positioned near the retaining spring, a curved bend at the distal end of the main body forming a stabilizing arm, and a securing tab extending from the stabilizing arm dimensioned to fit into an aperture in a groove on the brake assembly;
inserting the securing tab into the aperture in the groove;
rotating the tool downward so that it rests on the brake assembly;
attaching the spring to a first attachment aperture in the brake assembly and positioning its free end near a second attachment aperture;
releasably engaging the free end of spring with the hooked end of a lever bar having a handle end and a hooked end;
resting the lever bar on the fulcrum crossbar and pushing downward on the handle end to force upward the free end of the spring, thereby stretching the spring.
